(19) United States
(12) Patent Application Publication
(10) Pub. No.: US 2002/0056217 A1
(43) Pub. Date: May 16, 2002

(54) Consumable business card holder

(76) Inventors: Jonnie Sue Odom, Maryville, TN (US); Jeffrey C. Bouton, Maryville, TN (US)

Correspondence Address: Jonnie Sue Odom, Jeffrey Carroll Bouton, P.O. Box 4954, Maryville, TN, 37801, US

(21) Appl. No.: 09/940,998

(22) Filed: Aug. 28, 2001

Related U.S. Application Data
(60) Provisional application No. 60/228,779, filed on Aug. 29, 2000.

(51) Int. Cl. G09F 3/18

(52) U.S. Cl. 40/642.02

(57) ABSTRACT

A consumable business card holder provides a container for the presentation and consumption of an edible card or removable non-consumable card. The usefulness of the consumable business card holder provides a unique, effective method of presenting a business image for marketing, advertising and promotional purposes. The invention is comprised of a recessed center area to secure the card, raised outer rim for preventing damage to said icing border to allow stackability in packaging. Size substantially corresponds to, but larger than said card.

### CROSS-REFERENCE TO RELATED APPLICATIONS

This application is entitled to the benefit of provisional patent application No. 60/228/779 filed Aug. 29, 2000.

### BACKGROUND

1. Field Of Invention

This present invention relates generally to the field of containers, or holders, specifically consumable business card holders.

2. Description of Prior Art

Containers and holders of various shapes, materials, sizes and purposes have always been available. What separates one container from another is its effectiveness. For example, while tea cup holders have been know and used for a long time, a tea cup holder attached to a brief case is relatively new. Same can be said about business card holders.

Various types of business card holders are used. The purpose of a business Card and its holder is to gain effective recognition. U.S. Pat. No. 6,240,989 to Masoud (2001) consist of plastic material content; U.S. Pat. No. 4,356,646 to Johnson (1982) consists of metal content. These two prior arts address the advantages of the material content used to make the card holders.

Originally card holders were paper bags and paper boxes. Next the plastic and metal card holders were used to hold business and other types of cards useful in advertising and information. The card holder in U.S. Pat. No. 4,356,646 Johnson (1982) is an example of a card holder used to house and maintain information. The card holder has a purpose other than maintaining cards, it also contains a tab portion for permanently embossed writing on the card holder. The purpose is for the card holder and the card to remain together for an extended purpose. U.S. Pat. No. 919,736 Loesch (1908) is an edible label that during that time would be considered as informational as the business card. A consumable label which advertises the product. U.S. Pat. No. 5,017,394 Macpherson (May 21, 1991) makes it possible for the consumable business card holder to contain a consumable card.

### SUMMARY

The consumable business card holder is a unique business card holder. The consumable business card holder offers advantages in the novel presentation of a consumable card. The consumable business card holder offers the unexpected, surprise and smiles. A new concept in the presentation of business cards.

### OBJECTS AND ADVANTAGES

This invention relates to a memorable, informable and novel card holder. More particularly, it relates to an improved, different presentation holder presently being used by sales staffs, CEO', managers, company personnel and people desiring to leave a lasting impression. Accordingly, it is an object of the consumable business card to provide a happy and tasteful experience as well as lasting thoughts. People in the business profession are continually seeking new avenues with the consumable business card holders qualities. In order to sell, it must appeal first. The consumable business card holder will represent new meaning for the business card holder, the object to leave a lasting impression.

### DRAWING FIGURES

FIG. 1A is an elevational front view of a consumable business card holder.

FIG. 1B is a front elevational sectional view of a consumable business card holder.

FIG. 2A is a side sectional view of a consumable business card holder.

FIG. 2B is a perspective side view of a consumable business card holder.

FIG. 3 is a perspective bottom view of a consumable business card holder.

### REFERENCE NUMERALS IN DRAWINGS

11 consumable business card holder

12 raised protective rim

13 edible business card

14 decorative piped icing

### DESCRIPTION OF THE PREFERRED EMBODIMENT

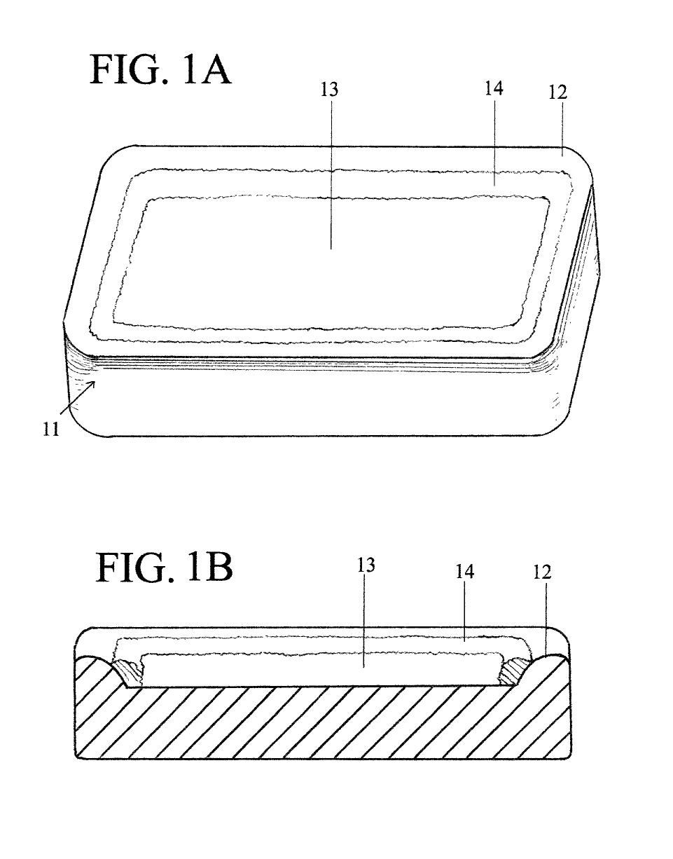

Referring now to FIG. 1A, which is an elevated front view of a consumable business card holder (11) (3¼″ W×4 l/2″ L×1″ H). The center-recessed area holds the edible business card (13) (2″ W×3½′ L). The edible business card is trimmed out with decorative piped icing (14), and protected by the “raised rim” (12) around the top outer edge of the holder (11).

Referring now to FIG. 1B, that is a slightly elevated sectional view of the front which demonstrates the staggered levels, the raised rim (12) that protects the decorative piped icing (14) which borders the edible business card (13).

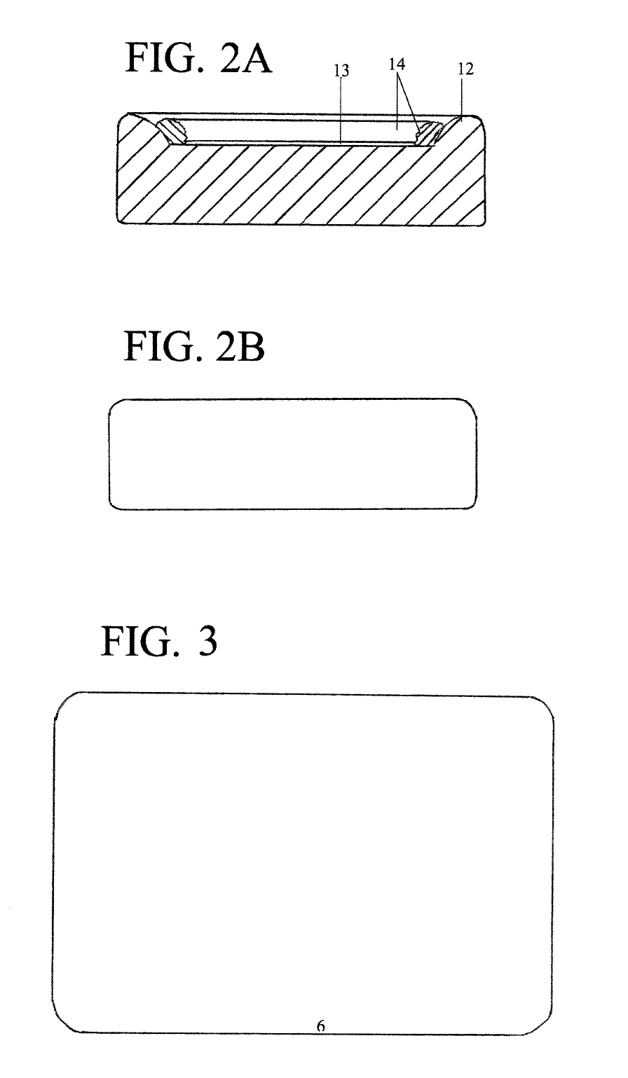

Referring now to FIG. 2A, that is a side sectional view that demonstrates the edible card (13) is placed in the recessed center area. The decorative piped icing rests on the outside edge of the edible card (13) and reaches upward 5/16″ towards the top edge of the raised rim (12).

Referring now to FIG. 2B, which is a perspective side view that demonstrates how the holder can be packaged, handled and stacked for shipping without damaging the edible card or piped icing.

Referring now to FIG. 3, which is a perspective bottom view. The bottom is flat.

Now that the invention has been described, what is claimed as new and desired to be secured by letters patent is;

1. A consumable card holder for retaining an edible business card. Said card holder being fabricated of consumable materials.

What we claim as new and desire to secure by Letters Patent is as follows:

1. A new article of manufacture, a consumable business card holder for the presentation of consumable and non consumable cards comprising of:
(a) a size substantially corresponding to, but larger than said card
(b) a recessed center area to secure card
(c) a decorative piped icing border surrounding card
(d) elevated sides, raised outer rim
(e) means for preventing damage to said icing border, allows stackability in packaging.
